(19) United States
(12) Patent Application Publication
(10) Pub. No.: US 2007/0230021 A1
(43) Pub. Date: Oct. 4, 2007

(54) Flying height control for read-to-write and write-to-read transitions

(75) Inventors: Erhard Schreck, San Jose, CA (US); James McFadyen, Redwood City, CA (US)

Correspondence Address: FOLEY & LARDNER, 2029 CENTURY PARK EAST, SUITE 3500, LOS ANGELES, CA, 90067, US

(73) Assignee: Maxtor Corporation

(21) Appl. No.: 11/729,179

(22) Filed: Mar. 28, 2007

Related U.S. Application Data
(60) Provisional application No. 60/743,914, filed on Mar. 29, 2006.

(51) Int. Cl. G11B 21/02

(52) U.S. Cl. 360/75

(57) ABSTRACT

Various embodiments of the present invention are directed to substantially eliminating transient changes in a flying height of a head during read-to-write and write-to-read transitions. In various embodiments, flying height transient compensation is provided to substantially maintain a desired flying height during one or both of read-to-write and write-to-read transitions.

### CROSS-REFERENCE TO RELATED PATENT APPLICATIONS

Embodiments of the present invention relate to U.S. Provisional Application. Ser. No. 60/743,914, filed Mar. 29, 2006, entitled “Write Toggle Transient Compensation Network for Fly Height Adjust Applications”, the contents of which are incorporated by reference herein and which is a basis for a claim of priority.

### BACKGROUND

Embodiments of the present invention relate generally to flying-height control and, more particularly, to active control of a flying height of a head.

A major goal among many disk drive manufacturers is to continue to increase disk drive performance while still maintaining disk drive reliability. One feature of a disk drive that impacts both disk drive performance and disk drive reliability is a flying height of a head over a recording medium. If a flying height of a head over a recording medium is too high, then poor magnetic performance may result, and such poor magnetic performance may lead to an increased bit error rate, slower read and write operations, and a decrease in possible storage density. On the other hand, if a flying height of a head over a recording medium is too low, then the head may contact the recording medium, and such contact may damage the head and the recording medium.

A disk drive typically includes a head and a recording medium. The head typically includes a read structure and a write structure. The read structure generally comprises a read element for reading data from the recording medium. The write structure generally comprises a write pole, a write yoke, and write coils surrounding the write yoke, where the write structure allows for writing data to the recording medium. The head is typically configured to fly on an air bearing that is generated by rotation of the recording medium.

During write operations in various disk drives, a current may be passed through one or more write coils that surround at least a portion of a write yoke. The current in the write coils produces a magnetic flux in the write yoke that is able to be focused at a write pole, and the magnetic flux is able to pass from the write pole to a recording medium so as to write data to the recording medium. The current in the write coils that is provided during write operations also causes the write coils to generate heat that is spread to surrounding portions of a head that includes the write coils. Such heat provided by the write coils during write operations may lead to write pole tip protrusion (WPTP) in which thermal distortions of materials within the head result in a lowering of a flying height of the head.

During read operations in various disk drives, there is generally no current passed through the write structure and, thus, no heat generated by the write structure to maintain WPTP. As a consequence, in such disk drives, a flying height of a head may be unnecessarily too high during read operations unless the flying height of the head is lowered by another source. Various schemes have been proposed for providing flying height adjustment (FHA) to adjust a fly height or flying height (FH) of a head, so as to allow for lowering the flying height of the head during read operations. For example, some disk drives include a FHA heater for heating materials in a head of the disk drive, so as to cause thermal distortions of the materials within the head and, as a consequence, cause a lowering of a flying height of the head.

Some FHA head designs are controlled such that no current is provided to the FHA heater during write operations, and then a current of a specified constant value is provided to the FHA heater during read operations. Such FHA head designs have a problem in that they are subject to transient changes in flying height when the head switches from read operations to write operations (read-to-write transitions) and from write operations to read operations (write-to-read transitions). Transient changes in a flying height in such designs are at least partially due to the fact that the heater, which dissipates power for FHA, is in a physically different part of the head structure from the write structure, which dissipates power that causes WPTP, thus creating different dynamics for each with regard to thermal distortion of the head.

A flying height of a head is affected by both thermal distortions due to FHA and thermal distortions due to WPTP. Whenever the dynamics of the thermal distortions of WPTP and FHA are not identical, there is a potential for transient flying height changes during read-to-write and write-to-read transitions. For example, if an actuation speed of thermal distortion growth due to FHA is greater than an actuation speed of thermal distortion decay of WPTP, then a transient protrusion results during write-to-read transitions. This is because once the write operation ends and the write structure stops dissipating power, the thermal distortion of the head due to heat from the write structure would begin to decay, but the heater begins dissipating power during the read operation, which leads to thermal distortion growth of the head and, in the example, at a faster rate than the thermal distortion decay of WPTP. As a consequence, in the example, a transient protrusion in flying height would result and would last until the thermal distortion due to WPTP ended sometime in a steady-state condition during the read operation.

FIG. 1 is a graph illustrating an example of a normalized spacing change versus time for thermal distortion growth due to FHA, a normalized spacing change versus time for thermal distortion decay of WPTP, and a normalized spacing change versus time for a difference between the thermal distortion decay of WPTP and the thermal distortion growth due to FHA. Such dynamics as illustrated in FIG. 1 may occur in FHA head designs where no current is provided to an FHA heater during write operations, and then a current of a specified constant value is provided to the FHA heater during read operations.

The graph of FIG. 1 illustrates the problem in which the actuation speed of thermal distortion growth due to FHA is greater than the actuation speed of thermal distortion decay of WPTP. As a result, for head designs with thermal distortion dynamics as illustrated in FIG. 1, a transient protrusion in flying height would result during write-to-read transitions, as illustrated by the difference between the thermal distortion decay of WPTP and the thermal distortion growth due to FHA. In some such head designs, a write-to-read transition may induce a FH transient change of approximately 10% of the total WPTP spacing change value. For example, in a head design where WPTP is 3 nm, the transient change may be 0.3 nm. If the desired flying height is 1 nm, then a 0.0.3 nm transient spacing change would represent 30% of the total flying height budget, which may lead to incorrect operation of the disk drive and/or may cause damage to the disk drive.

Other differences between WPTP and FHA actuation speeds may also lead to operational problems in head designs in which no current is provided to the FHA heater during write operations, and then a current of a specified constant value is provided to the FHA heater during read operations. For example, if an actuation speed of thermal distortion growth due to WPTP is greater than an actuation speed of thermal distortion decay of FHA from the FHA heater, then a transient protrusion results during read-to-write transitions. If an actuation speed of thermal distortion decay of WPTP is greater than an actuation speed of thermal distortion growth due to FHA, then a transient recession results during write-to-read transitions. Also, if an actuation speed of thermal distortion decay of FHA from the FHA heater is greater than an actuation speed of thermal distortion growth due to WPTP, then a transient recession results during read-to-write transitions.

Flying height transients are undesirable in at least two respects: (i) poor magnetic performance results when flying too high due to transient recessions; and (ii) there is a potential for head-to-disk contact when flying too low due to transient protrusions. Thus, in light of the above mentioned problems, there is a need for improved flying height control during read-to-write and write-to-read transitions.

### SUMMARY

Various embodiments of the present invention are directed to substantially eliminating transient changes in a flying height of a head during read-to-write and write-to-read transitions. In various embodiments, flying height transient compensation is provided to substantially maintain a desired flying height during one or both of read-to-write and write-to-read transitions.

A circuit in accordance with an embodiment of the present invention includes a head heater controller that substantially destructively cancels a transient fly height change resulting from a transition between a write operation and a read operation.

A system in accordance with an embodiment of the present invention includes circuitry for controlling a heating element. The heating element allows for providing heat to a head. The head allows for performing read operations and write operations. The circuitry is configured to control the heating element during a transition from a read operation to a write operation such that thermal distortion decay of the head due to reduced heat from the heating element substantially matches thermal distortion growth of the head due to increased heat from a write structure.

A method in accordance with an embodiment of the present invention includes controlling a heating element when a head transitions from performing a write operation to performing a read operation such that thermal distortion growth of the head due to increased heat from the heating element substantially matches thermal distortion decay of the head due to reduced heat from a write structure.

Thus, various embodiments of the present invention allow for flying height control during one or both of read-to-write and write-to-read transitions.

### BRIEF DESCRIPTION OF THE DRAWINGS

FIG. 1 is a graph illustrating an example of a normalized spacing change versus time for thermal distortion growth due to FHA, a normalized spacing change versus time for thermal distortion decay of WPTP, and a normalized spacing change versus time for a difference between thermal distortion decay of WPTP and thermal distortion growth due to FHA;

FIG. 2 illustrates a disk drive in accordance with an embodiment of the present invention;

FIG. 3 illustrates an actuator arm assembly and a disk stack in accordance with an embodiment of the present invention;

FIG. 4 illustrates a block diagram of a host device, circuitry, and a head disk assembly (HDA) in accordance with an embodiment of the present invention;

FIG. 5 illustrates a side view of a portion of a HDA in accordance with an embodiment of the present invention;

FIG. 6A illustrates an embodiment of a heating element in accordance with an embodiment of the present invention;

FIG. 6B illustrates an embodiment of a heating element in accordance with an embodiment of the present invention;

FIG. 6C illustrates an embodiment of a heating element in accordance with an embodiment of the present invention;

FIG. 6D illustrates an embodiment of a heating element in accordance with an embodiment of the present invention;

FIG. 7A illustrates a system in accordance with an embodiment of the present invention;

FIG. 7B illustrates a system in accordance with an embodiment of the present invention;

FIG. 7C illustrates a system in accordance with an embodiment of the present invention;

FIG. 8 illustrates a flowchart of a method in accordance with an embodiment of the present invention;

FIG. 9 illustrates a graph with example measured values of a displacement of an air bearing surface of a head at multiple time points and an exponential function fit of the measured values;

FIG. 10 illustrates an example of a simulation model in accordance with an embodiment of the present invention;

FIG. 11 illustrates sample output results of a simulation using a simulation model with a first order equalizer in accordance with an embodiment of the present invention;

FIG. 12 illustrates sample output results of a simulation using a simulation model with a third order equalizer in accordance with an embodiment of the present invention;

FIG. 13A illustrates a fly height controller in accordance with an embodiment of the present invention;

FIG. 13B illustrates a fly height controller in accordance with an embodiment of the present invention; and

FIG. 14 illustrates a flowchart of a method in accordance with an embodiment of the present invention.

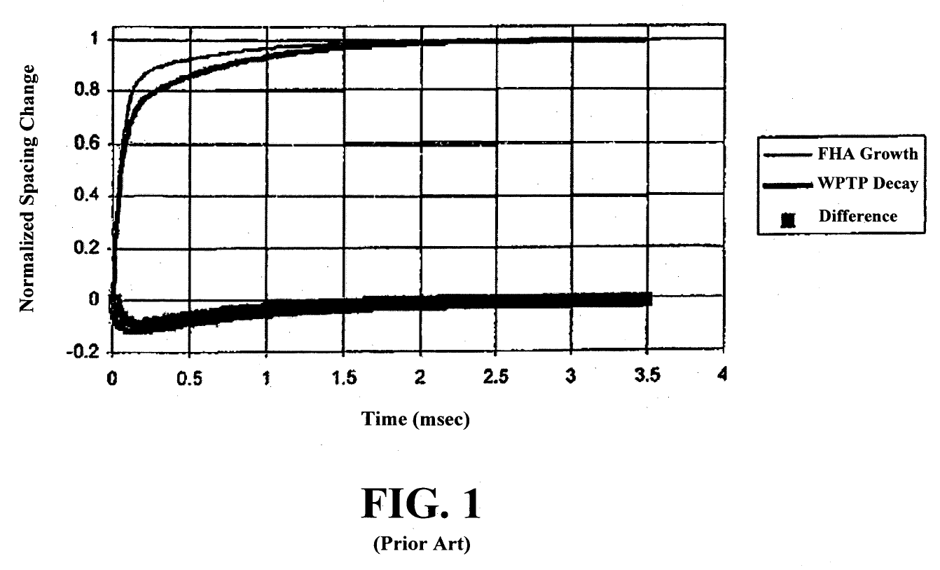

### DETAILED DESCRIPTION OF PREFERRED EMBODIMENTS

Reference will now be made to the accompanying drawings, which assist in illustrating various pertinent features of embodiments of the present invention. Although embodiments of the present invention will now be described primarily in conjunction with disk drives, it should be expressly understood that embodiments of the present invention may be applicable to other applications as well. For example, embodiment of the present invention may be applied to compact disc (CD) drives, digital versatile disk (DVD) drives, and the like. In this regard, the following description of a disk drive is presented for purposes of illustration and description. Like numbers refer to like elements throughout the description of the figures. Although some of the diagrams include arrows on communication paths to show what may be a primary direction of communication, it is to be understood that communication may occur in the opposite direction to the depicted arrows.

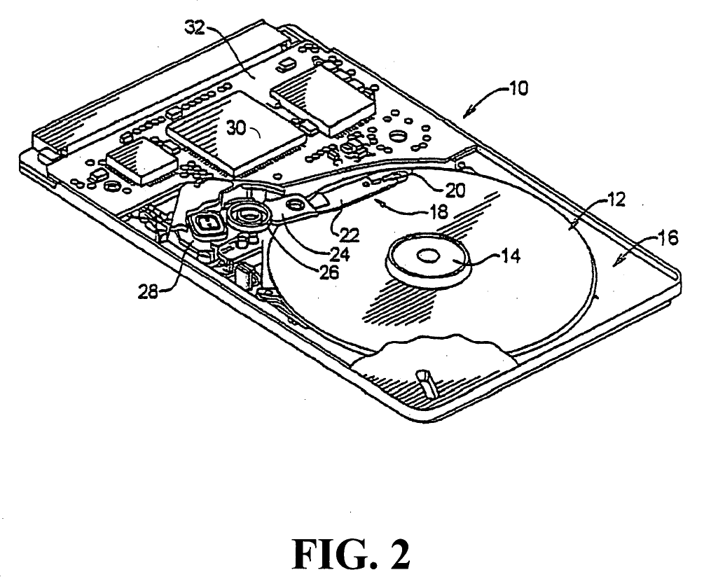

A diagrammatic representation of a disk drive, generally designated as 10, is illustrated in FIG. 2. The disk drive 10 includes a disk stack 12 (illustrated as a single disk in FIG. 2) that is rotated by a spindle motor 14. The spindle motor 14 is mounted to a base plate 16. An actuator arm assembly 18 is also mounted to the base plate 16. The disk drive 10 is configured to store and retrieve data responsive to write and read commands from a host device. A host device can include, but is not limited to, a desktop computer, a laptop computer, a personal digital assistant (PDA), a digital video recorder/player, a digital music recorder/player, and/or another electronic device that can be communicatively coupled to store and/or retrieve data in the disk drive 10.

The actuator arm assembly 18 includes a head 20 (or transducer) mounted to a flexure arm 22 which is attached to an actuator arm 24 that can rotate about a pivot bearing assembly 26. The head 20 may, for example, include a magnetoresistive (MR) element, a thin film inductive (TFI) element, or the like. The actuator arm assembly 18 also includes a voice coil motor (VCM) 28 which radially moves the head 20 across the disk stack 12. In various embodiments, the disk drive 10 includes circuitry 30. In some embodiments, the circuitry 30 is enclosed within one or more integrated circuit packages mounted to a printed circuit board (PCB) 32. The circuitry 30 may include digital circuitry and/or analog circuitry. For example, the circuitry 30 may include a gate array, a processor-based instruction processing device, passive circuit elements, or the like, and in various embodiments may execute firmware, software, or the like.

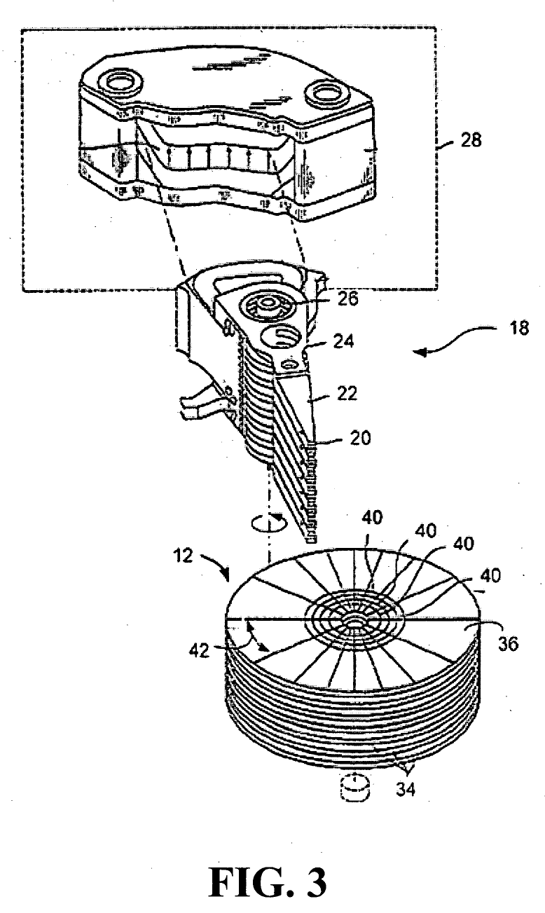

Referring now to the illustration of FIG. 3, the disk stack 12 typically includes a plurality of disks or recording mediums 34, each of which may have a pair of disk surfaces 36. The recording media 34 are mounted on a cylindrical shaft and are rotated about an axis by the spindle motor 14 (refer to FIG. 2). The actuator arm assembly 18 includes a plurality of the heads 20, each of which is positioned to be adjacent to a corresponding one of the disk surfaces 36. Each head 20 is mounted to a corresponding one of the flexure arms 22. The VCM 28 operates to move the actuator arm 24, and thus moves the heads 20 across their respective disk surfaces 36. The heads 20 are configured to fly on an air cushion relative to the data recording surfaces 36 of the rotating recording media 34 while writing data to the data recording surface responsive to a write command or while reading data from the data recording surface to generate a read signal responsive to a read command.

FIG. 3 further illustrates tracks and spokes on the recording media 34. Data is stored on the recording media 34 within a number of concentric tracks 40 (or cylinders). Each track 40 is divided into a plurality of radially extending sectors 42. Each sector is further divided into a servo sector and a data sector. The servo sectors of the recording media 34 are used for, among other things, positioning the heads 20 so that data can be properly written onto and read from a selected one of the tracks 40. The data sectors are where non-servo related data (i.e., host device data) are stored and retrieved. In various other embodiments, each of the recording media 34 may have one or more spiral tracks, rather than the concentric tracks 40.

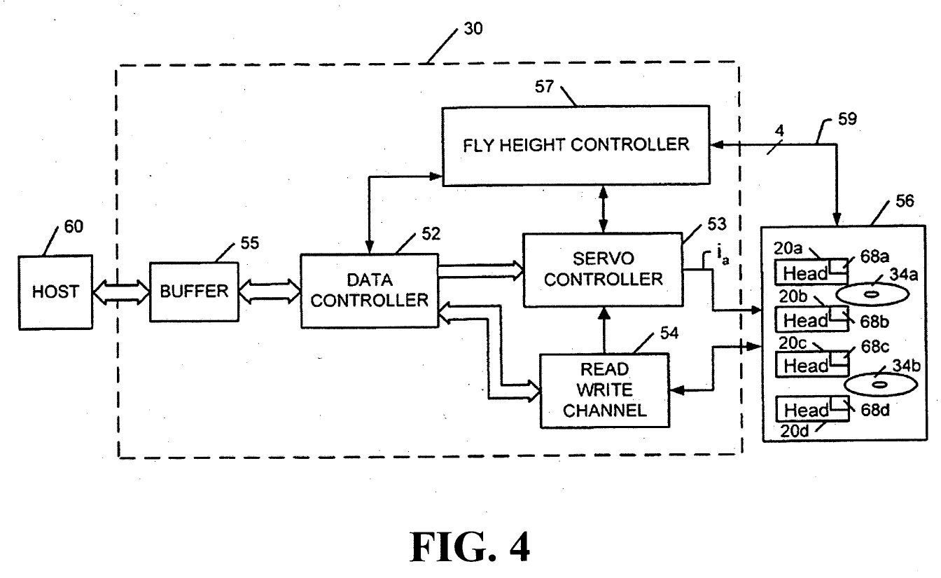

FIG. 4 illustrates a block diagram of a host device 60, the circuitry 30, and a head disk assembly (HDA) 56 in accordance with an embodiment of the present invention. In various embodiments, the circuitry 30 includes a head heater controller or fly height controller 57. In some embodiments, the circuitry 30 further includes a data controller 52, a servo controller 53, a read write channel 54, and a buffer 55. Although the controllers 52, 53, and 57, the buffer 55, and the read write channel 54 have been shown as separate blocks for purposes of illustration and discussion, it is to be understood that, in various embodiments, their functionality described herein may be integrated within a common integrated circuit package or distributed among more than one integrated circuit package. In some embodiments, the host device 60 is communicatively connected to the buffer 55.

In various embodiments, the HDA 56 includes a plurality of the recording mediums 34a-b, and a plurality of the heads 20a-d mounted on the actuator arm assembly 18 (refer to FIG. 3) and positioned adjacent to corresponding data storage surfaces of the recording media 34a-b. The buffer 55 allows for buffering commands and data. The data controller 52 is configured to carry out write commands by formatting associated data into blocks with appropriate header information, and transferring the formatted data from the buffer 55, via the read write channel 54, to logical block addresses (LBAs) on a corresponding one of more of the recording media 34 identified by the associated write command.

The read write channel 54 can operate in a conventional manner to convert data between the digital form used by the data controller 52 and the analog form conducted through the heads 20 in the HDA 56. The read write channel 54 provides position information read by the HDA 56 to the servo controller 53. The position information can be used to detect the locations of the heads 20 in relation to LBAs on the recording media 34. The servo controller 53 can use LBAs from the data controller 52 and the position information to seek the heads 20 to addressed tracks and blocks on the recording media 34, and to maintain the heads 20 aligned with the tracks while data is written to or read from the recording media 34.

The fly height controller 57 is configured to controllably heat the heads 20 to control their flying heights relative to the data recording surfaces 36 of the recording media 34. With continuing reference to FIG. 4, the HDA 56 includes a plurality of heaters or heating elements 68a-d attached to or as part of corresponding ones of the heads 20a-d. The fly height controller 57 generates heater signals 59 which are conducted through the heating elements 68a-d to generate heat therefrom and, thereby, heat the heads 20a-d. The fly height controller 57 controls the heater signals 59 to control heating of the heads 20a-d and cause a controllable amount of thermally-induced elastic deformation of the heads 20a-d and, thereby, control the flying heights of the heads 20a-d.

Although four heater signals 59 have been shown in FIG. 4, which may be used to separately control heating by different ones of the heating elements 68a-d, it is to be understood that more or less heater signals 59 may be used to control the heating elements 68a-d and that, for example, the heating elements 68a-d may be controlled by a single common heater signal 59.

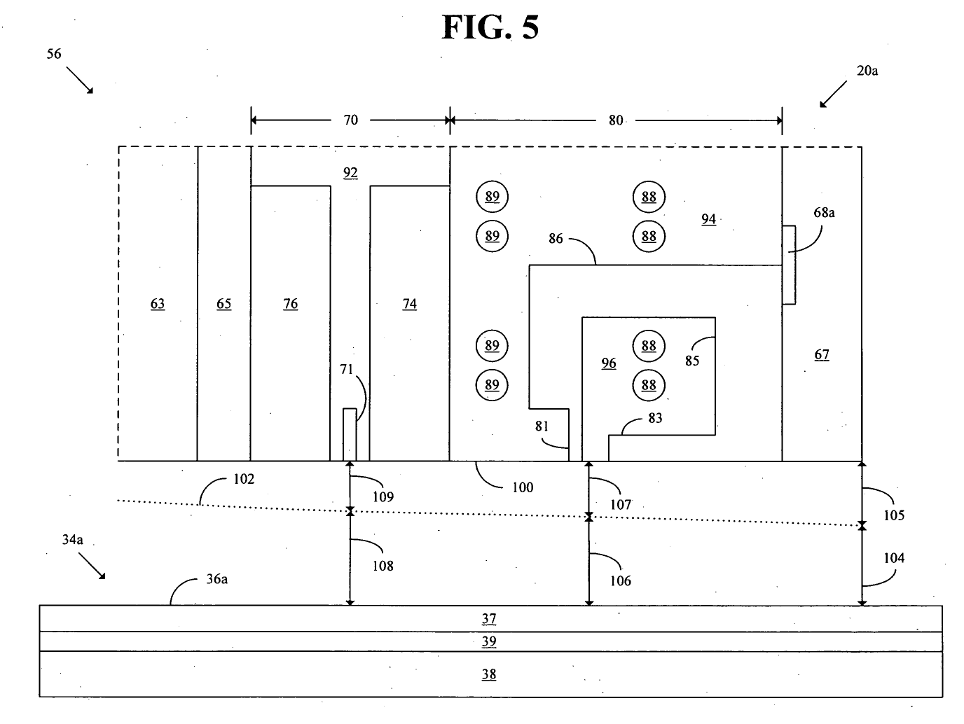

FIG. 5 illustrates a side view of a portion of the HDA 56 in accordance with an embodiment of the present invention. The HDA 56 comprises the recording medium 34a and the head 20a. The recording medium 34a allows for storing data through magnetization, and comprises a recording layer 37, a soft underlayer (SUL) 38, and a non-magnetic spacer layer 39. In various embodiments, the recording layer 37 comprises a magnetic material with a plurality of grains (not shown) that are oriented perpendicular to the medium, where a magnetization of each grain of the plurality of grains may point either “up” or “down”. In various embodiments, the SUL 38 comprises a particular magnetic material that is softer than the magnetic material of the recording layer 37. The recording layer 37 has a top surface 36a.

In some embodiments, the recording layer 37 comprises a magnetically hard material with a strong perpendicular magnetic anisotropy, a relatively high coercivity compared to the SUL 38, and a relatively low permeability compared to the SUL 38. Also, in some embodiments, the SUL 38 comprises a magnetically soft material with a lower coercivity than the recording layer 37 and a higher permeability than the recording layer 37. The recording layer 37 is separated from the SUL 38 by the non-magnetic spacer layer 39. During writing operations, a magnetic flux from a write pole 81 of the head 20a may pass vertically through the recording layer 37 to the SUL 38, so as to allow for perpendicular recording by magnetizing one or more of the plurality of grains of the recording layer 37, and then the magnetic flux may return to a write shield 83 and to a write return yoke 85 of the head 20a from the SUL 38.

The head 20a comprises a substrate 63, an undercoat material such as an undercoat layer 65, a read structure 70, a write structure 80, an overcoat layer 67, and the heating element 68a. The read structure 70 comprises a read element 71, a top read shield 74, a bottom read shield 76, and a read structure insulation portion 92. The write structure 80 comprises the write pole 81, the write shield 83, the write return yoke 85, a write yoke 86, one or more write coils 88, one or more bucking coils 89, a first write structure insulation portion 94, and a second write structure insulation portion 96. In various embodiments, such as the embodiment illustrated in FIG. 5, the write return yoke 85 is separate from the top read shield 74. However, in various other embodiments, the top read shield 74 of the read structure 70 may also be used as the write return yoke 85 of the write structure 80. The head 20a has an air bearing surface (ABS) 100 that may face the top surface 36a of the recording medium 34a when the head 20a is performing read and write operations.

During writing operations, a current is passed through the one or more write coils 88, which surround a portion of the write yoke 86. As a consequence, a magnetic flux is produced in the write yoke 86 and is focused at the write pole 81, where the magnetic flux passes from the write pole 81 to the recording medium 34a in order to write data to the recording medium 34a. The magnetic flux from the write pole 81 that is passed to the recording medium 34a returns from the recording medium 34a to the write shield 83 and to the write return yoke 85 and then from the write return yoke 85 back to the write yoke 86.

A direction of current through the one or more write coils 88 varies depending on a direction of magnetization to be produced in the recording layer 37 for a given bit. When a current is passed through the one or more write coils 88, a current is passed through the one or more bucking coils 89 in an opposite direction from a direction of current in the one or more write coils 88, so as to help prevent a magnetic field from being generated in the read structure 70 due to the current in the one or more write coils 88 and, thus, to aid in decoupling the read structure 70 from the write structure 80. When no data is being written to the recording medium 34a, a current purposely applied to the one or more write coils 88 for writing data may be stopped, such that ideally no current would flow through the one or more write coils 88 when not performing write operations.

The read element 71 allows for reading data from the recording medium 34a based on magnetic fields provided from the recording medium 34a. The read element 71 may utilize various types of read sensor technologies, such as anisotropic magnetoresistive (AMR), giant magnetoresistive (GMR), tunneling magnetoresistive (TuMR), or the like. The term “magnetoresistive sensor” is used in the present application to encompass all those types of magnetoresistive sensor technologies and any others in which a variation in a resistance of a sensor due to an application of an external magnetic field is detected.

In various embodiments, the read element 71 comprises an AMR read element, where the AMR read element allows for reading data from the recording medium 34a by detecting a change in a magnetic field from the recording medium 34a. In other embodiments, the read element 71 comprises a GMR read element, where the GMR read element allows for reading data from the recording medium 34a by directly detecting a magnetic field from the recording medium 34a. GMR read elements are typically more sensitive to small magnetic fields than are AMR read elements and, as a result, it may be preferable to use a GMR read element in a perpendicular recording system to improve reading of data. In still other embodiments, the read element 71 comprises a TuMR read element. TuMR read elements are similar to GMR read elements, but various TuMR read elements may rely on spin dependent tunneling currents across an isolation layer, while various GMR read elements may rely on spin dependent scattering mechanisms between two or more magnetic layers.

The top read shield 74 and the bottom read shield 76 each comprise a magnetic material. In various embodiments, the top read shield 74 and the bottom read shield 76 each comprise a magnetically soft material, such as a nickel-iron alloy, or the like. Also, in various embodiments, the top read shield 74 and the bottom read shield 76 have a high permeability to perpendicular magnetic fields, so as to capture stray magnetic fields from the recording medium 34a. The read element 71 is located at least partially between the top read shield 74 and the bottom read shield 76. In various embodiments, the read element 71 is located entirely between the top read shield 74 and the bottom read shield 76.

The substrate 63 is a base layer of the head 20a onto which other layers of the head 20a are deposited to form the head 20a. In various embodiments, the substrate 63 comprises a ceramic material or the like. Also, in various embodiments, the substrate 63 comprises a thermally conductive material. In some embodiments, the substrate 63 comprises a composition of alumina and titanium-carbide, or the like. The undercoat layer 65 at least partially provides for electrical insulation between the read structure 70 and the substrate 63. In Various embodiments, the undercoat layer 65 comprises a thermally insulating material. Also, in various embodiments, the undercoat layer 65 comprises an electrically insulating material. In some embodiments, the undercoat layer 65 comprises alumina, or the like.

The read structure 70 allows for reading magnetic fields from the recording medium 34a. In various embodiments, the read structure 70 is located at least partially between a portion of the undercoat layer 65 and a portion of the write structure 80. In some embodiments, the read element 71 is located at least partially between a portion of the top read shield 74 and a portion of the bottom read shield 76. Also, in some embodiments, the bottom read shield 76 is located at least partially between a portion of the undercoat layer 65 and a portion of the top read shield 74. In various embodiments, the read structure insulation portion 92 provides insulation between the bottom read shield 76 and the read element 71 and provides insulation between the read element 71 and the top read shield 74. In some embodiments, the read structure insulation portion 92 covers a top surface of the bottom read shield 76 opposite the ABS 100 and covers a top surface of the top read shield 74 opposite the ABS 1100. In some embodiments, the top read shield 74 comprises a ferromagnetic material or the like. Also, in some embodiments, the bottom read shield 76 comprises a ferromagnetic material or the like. In various embodiments, the read structure insulation portion 92 comprises alumina, or the like.

The write structure 80 allows for providing particular magnetic fields to the recording medium 34a to write data to the recording medium 34a. In various embodiments, the write structure 80 is located at least partially between a portion of the read structure 70 and a portion of the overcoat layer 67. The first write structure insulation portion 94 surrounds a first portion of the one or more write coils 88, and the second write structure insulation portion 96 surrounds a second portion of the one or more write coils 88. In various embodiments, the first write structure insulation portion 94 and the second write structure insulation portion 96 comprise alumina, or the like. In some embodiments, the write structure 80 comprises the one or more bucking coils 89, where the one or more bucking coils 89 are located at least partially between a portion of the top read shield 74 and a portion of the write yoke 86. Also, in some embodiments, the one or more bucking coils 89 are surrounded by the first write structure insulation portion 94.

The overcoat layer 67 at least partially protects the write structure 80 from direct contact by materials such as dust and other particulates. In various embodiments, the overcoat layer 67 electrically insulates the write structure 80. In some embodiments, the overcoat layer 67 comprises alumina, or the like. In various embodiments, the heating element 68a is located at least partially in the overcoat layer 67, such as in the embodiment illustrated in FIG. 5. In various other embodiments, the heating element 68a may be located in other positions, such as at least partially in the undercoat layer 65, between the read structure 70 and the write structure 80, above the head 20a, or the like. In some embodiments, a surface of the overcoat layer 67 defines a trailing surface of the head 20a.

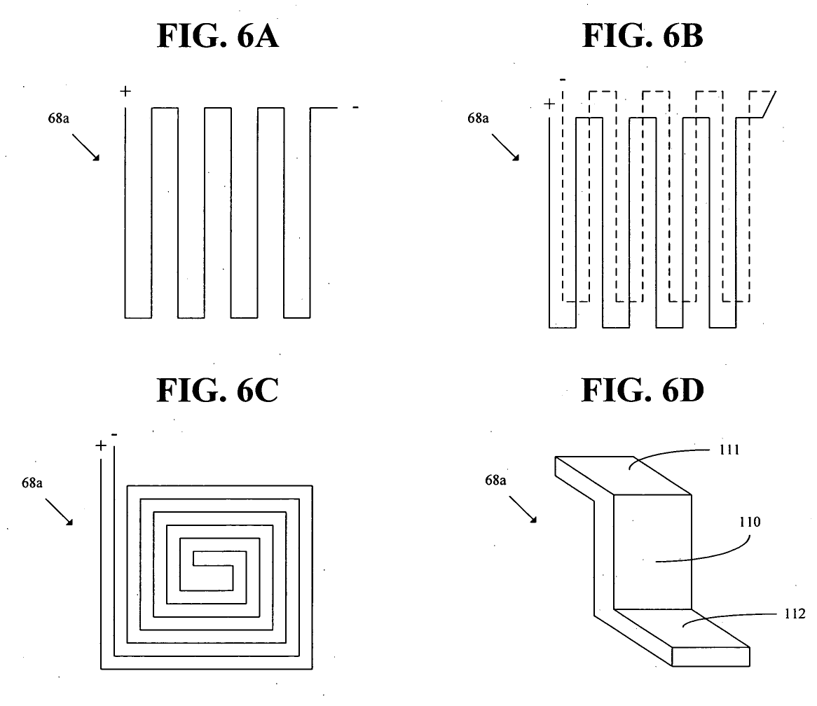

The heating element 68a allows for providing heat. An amount of heat provided by the heating element 68a is controllable by the fly height controller 57 (refer to FIG. 4). In some embodiments, the heating element 68a comprises a heating coil structure of a conductive material such as Ni₈₀Fe₂₀ (permalloy), Cu₆₀Ni₄₀ (constantan), Cu₈₈Sn₁₂ (bronze), Cu_{97.5}Mn_{3.5}, or the like. Three examples of possible coil structures for the heating element 68a are illustrated in FIGS. 6A, 6B, and 6C, respectively. Also, in some embodiments, the heating element 68a comprises a film heater. An example of a possible film heater for the heating element 68a is illustrated in FIG. 6D.

FIG. 6A illustrates an embodiment of the heating element 68a in which the heating element 68a is a heating coil having a serpentine path of conductive metal film. FIG. 6B illustrates an embodiment of the heating element 68a in which the heating element 68a is a heating coil having two serpentine coils like those shown in FIG. 6A, where one coil is illustrated on top of the other coil and there is a connection between the two coils at one end of each coil. The heating element 68a of the embodiment of FIG. 6B allows for electrical connections to each of the coils to be adjacent to each other, rather than at opposite ends of a structure as with the heating element 68a of the embodiment of FIG. 6A. In addition, a magnetic field induced by each layer of coils in the combined coil structure of the heating element 68a of the embodiment of FIG. 6B tends to cancel out a magnetic field induced by the opposite coil layer, since the currents flow in opposite directions.

FIG. 6C illustrates an embodiment of the heating element 68a in which the heating element 68a is a bifilar structure in which a coil remains generally in a single plane, but doubles back on itself, so that current flowing in half of the coil structure is flowing in a generally counter-clockwise direction and in the other half of the coil structure is flowing in a generally clockwise direction. The heating element 68a of the embodiment of FIG. 6C also allows for reducing a magnetic field induced by a current in the coil structure of the heating element 68a. FIG. 6D illustrates an embodiment of the heating element 68a in which the heating element 68a is a film heater with a heater film 110, a first lead 111, and a second lead 112. Such a film heater arrangement may be useful in applications where it is desired to use a conductor of a relatively high resistivity.

Referring again to FIGS. 4 and 5, in various embodiments, a current or voltage that is supplied to the heating element 68a is specified by the fly height controller 57. Also, in various embodiments, the fly height controller 57 may specify a power to be applied to the heating element 68a. A power dissipated by the heating element 68a may be expressed by the equation P_{H}=I_{H}²R_{H}, where P_{H} denotes the power dissipated by the heating element 68a, I_{H} denotes a current applied to the heating element 68a, and R_{H} denotes a resistance of the heating element 68a. The power dissipated by the heating element 68a may also be expressed by the equation P_{H}=V_{H}²/R_{H}, where V_{H} denotes a voltage applied to the heating element 68a.

When the heating element 68a is actuated by, for example, providing a current or voltage to the heating element 68a, at least some portions of the head 20a expand due to heat provided by the heating element 68a. This expansion causes the ABS 100 of the head 20a to distort so as to allow the ABS 100 of the head 20a to be closer to the top surface 36a of the recording medium 34a. An example of a distortion of the ABS 100 of the head 20a is illustrated by a dotted line 102 in FIG. 5. As is illustrated by the dotted line 102, the ABS 100 may not be distorted evenly when the heating element 68a provides heat. Instead, some portions of the head 20a may be displaced greater distances toward the top surface 36a of the recording medium 34a than other portions of the head 20a. Such differences in displacement may be due to differences in coefficients of thermal expansion of different materials in the head 20a, and may be due to the placement of the heating element 68a, because material in the head 20a located closer to the heating element 68a may be provided with more heat than material in the head 20a located farther from the heating element 68a.

When the heating element 68a provides heat to cause a displacement of the ABS 100 of the head 20a to, for example, the dotted line 102, there are different displacements of the overcoat layer 67, the write structure 80, and the read structure 70. After the displacement of the ABS 100 of the head 20a, the smallest distance between the displaced ABS 102 and the top surface 36a of the recording medium 34a is known as the minimum flying height (min FH). In FIG. 5, the min FH is indicated by a double-sided arrow 104 between the dotted line 102 and the top surface 36a of the recording medium 34a. It is common for the min FH to occur at a trailing edge of the head 20a. In various embodiments, a surface of the overcoat layer 67 that is opposite a surface of the overcoat layer 67 facing the write structure 80 is a trailing surface of the head 20a. Thus, a trailing edge displacement of the head 20a due to heat from the heating element 68a is indicated in FIG. 5 by a double-sided arrow 105 between an original position of the ABS 100 at an end of the overcoat layer 67 and the dotted line 102 for the displaced ABS of the head 20a at an end of the overcoat layer 67.

Moreover, after the displacement of the ABS 100 of the head 20a, a distance between the read element 71 and the top surface 36a of the recording medium 34a is known as the read gap flying height (read gap FH). In FIG. 5, the read gap FH is indicated by a double-sided arrow 108 between the dotted line 102 for the displaced ABS of the read structure 70 and the top surface 36a of the recording medium 34a. A read gap displacement is an amount that the ABS 100 is displaced at the location of the read element 71 and is indicated in FIG. 5 by a double-sided arrow 109 between the ABS 100 at the read element 71 and the dotted line 102 for the displaced ABS of the head 20a.

Also, after the displacement of the ABS 100 of the head 20a, a distance between the write structure 80, in a region between the write pole 81 and the write shield 83, and the top surface 36a of the recording medium 34a is known as the write gap flying height (write gap FH). In FIG. 5, the write gap FH is indicated by a double-sided arrow 106 between the dotted line 102 for the displaced ABS of the write structure 80 and the top surface 36a of the recording medium 34a. A write gap displacement is an amount that the ABS 100 is displaced at the write structure 80, between the write pole 81 and the write shield 83, and is indicated in FIG. 5 by a double-sided arrow 107 between the ABS 1100 at the write structure 80 and the dotted line 102 for the displaced ABS of the head 20a.

A similar displacement of the ABS 100 occurs when the head 20a performs write operations. During write operations, a current is passed through the one or more coils 88. As a consequence, there is some power dissipated by the one or more coils 88 when the current is passed through the one or more coils 88, and the power dissipation generates heat. The heat generated by the one or more coils 88 during a write operation leads to write pole tip protrusion (WPTP) in which thermal distortions of the materials in the head 20a lead to thermal distortion growth at the ABS 100 of the head 20a. In various embodiments, once the head 20a has completed a write operation, the provision of a current to the one or more coils 88 is ended, and there is a thermal distortion decay of the ABS 100 of the head 20a due to a reduction in power dissipated by the write structure 80.

In various embodiments, the fly height controller 57 is configured to control the heating element 68a to provide heat when the head 20a is performing read operations. The head 20a performs read operations by reading data from the recording medium 34a using the read element 71. In various embodiments, the data controller 52 provides a signal to the fly height controller 57 to indicate when a read operation or a write operation is being performed by the head 20a and the type of the operation. In some embodiments, the servo controller 53 provides a signal to the fly height controller 57 to indicate when a read operation or a write operation is being performed by the head 20a and the type of the operation.

A read-to-write transition occurs when the head 20a finishes performing a read operation and then begins performing a write operation. A write-to-read transition occurs when the head 20a finishes performing a write operation and then begins performing a read operation. In various embodiments, the fly height controller 57 controls the heating element 68a so as to keep a flying height of the head 20a substantially constant during read-to-write and write-to-read transitions. In some embodiments, the flying height of the head 20a that is kept substantially constant during read-to-write and write-to-read transitions is the read gap flying height 108. Also, in some embodiments, the flying height of the head 20a that is kept substantially constant during read-to-write and write-to-read transitions is the write gap flying height 106. In various embodiments, the flying height of the head 20a that is kept substantially constant during read-to-write and write-to-read transitions is the min flying height 104. In various other embodiments, the flying height of the head 20a that is kept substantially constant during read-to-write and write-to-read transitions may be defined as the flying height for any point on the ABS 100 of the head 20a.

By maintaining a flying height of the head 20a at a desired spacing during read-to-write and write-to-read transitions, various embodiments of the present invention allow for substantially eliminating flying height transient changes during such transitions. Flying height transients are undesirable in at least two respects: (i) poor magnetic performance results when flying too high due to transient recessions; and (ii) there is a potential for contact between the head 20a and the recording medium 34a when flying too low due to transient protrusions. Thus, by reducing such transient changes, a performance and reliability of the head 20a may be improved.

When the fly height controller 57 controls the heating element 68a to provide heat, such an operation is termed flying height adjustment (FHA) or dynamic flying height (DFH) control. When the heating element 68a begins providing heat for FHA, there is thermal distortion growth of the ABS 100 of the head 20a due to heat provided by the heating element 68a. On the other hand, when an amount of heat provided by the heating element 68a is reduced, there is a thermal distortion decay of the ABS 100 of the head 20a due to the reduced heat from the heating element 68a. The dynamics of thermal distortion of FHA and WPTP are different due to the fact that the heating element 68a is in a physically different location than the one or more coils 88. Because the dynamics of thermal distortion due to FHA and WPTP are not identical, there is a potential for transient flying height changes during read-to-write and write-to-read transitions. Transient changes in flying height are changes that may last for a time until a steady-state condition for flying height is reached.

Transient changes in flying height during read-to-write and write-to-read transitions are realized in head designs in which the heating element 68a is driven with a specified constant current or voltage for the duration of read operations so as to dissipate a same amount of power as is dissipated by the write structure 80 during write operations. In such head designs, if an actuation speed of thermal distortion growth due to FHA is greater than an actuation speed of thermal distortion decay of WPTP, then a transient protrusion results during write-to-read transitions. Also, if an actuation speed of thermal distortion growth due to WPTP is greater than an actuation speed of thermal distortion decay of FHA from the heating element 68a, then a transient protrusion results during read-to-write transitions. Moreover, if an actuation speed of thermal distortion decay of WPTP is greater than an actuation speed of thermal distortion growth due to FHA, then a transient recession results during write-to-read transitions. Furthermore, if an actuation speed of thermal distortion decay of FHA from the heating element 68a is greater than an actuation speed of thermal distortion growth due to WPTP, then a transient recession results during read-to-write transitions.

Various embodiments of the present invention are directed to substantially eliminating transient changes in a flying height of the head 20a during read-to-write and write-to-read transitions. In some embodiments, the fly height controller 57 is configured to control the heating element 68a during a transition of the head 20a from a read operation to a write operation, so as to substantially destructively cancel a net transient change in a flying height of the head 20a away from the recording medium 34a due to a change in power dissipated by the write structure 80. Also, in some embodiments, the fly height controller 57 is configured to control the heating element 68a during a transition of the head 20a from a write operation to a read operation, so as to substantially destructively cancel a net transient change in a flying height of the head 20a away from the recording medium 34a due to a change in power dissipated by the write structure 80.

In various embodiments, the fly height controller 57 substantially destructively cancels a transient fly height change resulting from a transition between a write operation and a read operation. In some embodiments, when a read operation precedes a write operation, the fly height controller 57 controls the heating element 68a during the transition from the read operation to the write operation such that thermal distortion decay of the head 20a due to reduced heat from the heating element 68a substantially matches thermal distortion growth of the head 20a due to increased heat from the write structure 80. Also, in some embodiments, when a write operation precedes a read operation, the fly height controller 57 controls the heating element during the transition from the write operation to the read operation such that thermal distortion growth of the head 20a due to increased heat from the heating element 68a substantially matches thermal distortion decay of the head 20a due to reduced heat from the write structure 80.

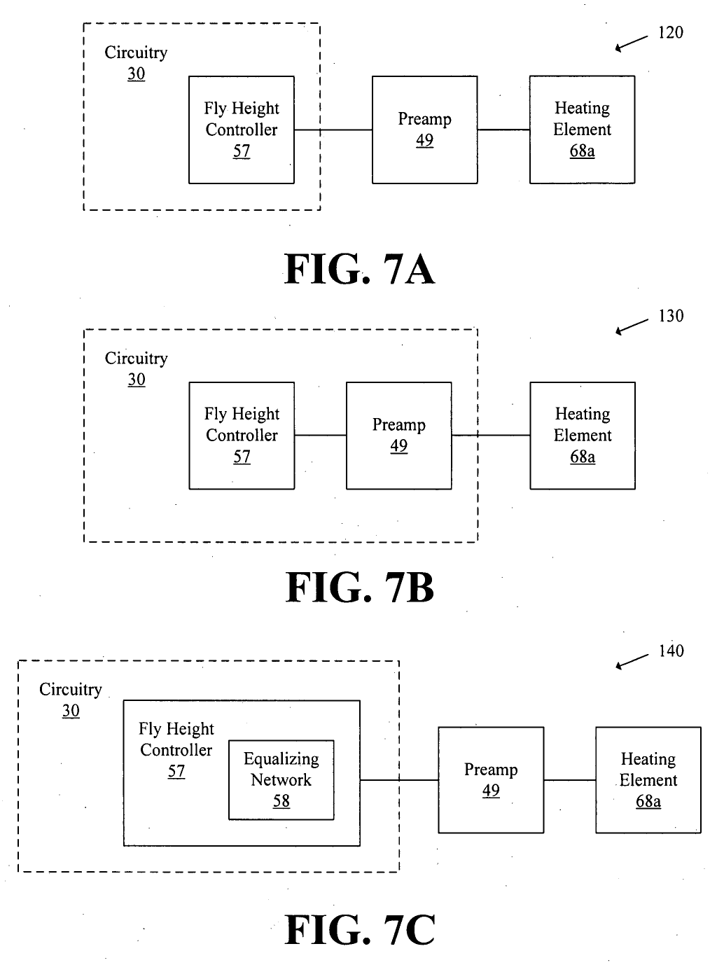

FIG. 7A illustrates a system 120 in accordance with an embodiment of the present invention. The system 120 includes the circuitry 30, a preamplifier or preamp 49, and the heating element 68a. The circuitry 30 includes the fly height controller 57. The fly height controller 57 provides a signal to the preamp 49 to control the heating element 68a. The preamp 49 provides an amplified signal to drive the heating element 68a. In various embodiments, the fly height controller 57 provides a digital signal to the preamp 49 to control the heating element 68a, and the preamp 49 performs digital-to-analog conversion to convert the digital signal from the fly height controller 57 into an analog signal that is then amplified and provided to drive the heating element 68a. In various other embodiments, the fly height controller 57 provides an analog signal to the preamp 49 to control the heating element 68a.

FIG. 7B illustrates a system 130 in accordance with another embodiment of the present invention. The system 130 is similar to the system 120, but the circuitry 30 in the system 130 includes the fly height controller 57 and the preamp 49. The circuitry 30 allows for controlling the heating element 68a. In various embodiments, the fly height controller 57 is configured to control the heating element 68a by adjusting a current supplied to the heating element 68a in a time dependent fashion during read-to-write and write-to-read transitions. Also, in various embodiments, the fly height controller 57 is configured to control the heating element 68a by adjusting a voltage supplied to the heating element 68a in a time dependent fashion during read-to-write and write-to-read transitions. In some embodiments, the fly height controller 57 is configured to control the heating element 68a by adjusting a power applied to the heating element 68a in a time dependent fashion during read-to-write and write-to-read transitions.

In various embodiments, the preamp 49 is configured to receive a signal from the fly height controller 57, and to treat the signal as a current request to drive the heating element 68a with a current specified by the fly height controller 57 in the current request. Also, in various embodiments, the preamp 49 is configured to receive a signal from the fly height controller 57, and to treat the signal as a voltage request to drive the heating element 68a with a voltage specified by the fly height controller 57 in the voltage request. In some embodiments, the preamp 49 is configured to receive a signal from the fly height controller 57, and to treat the signal as a power request to apply a power to the heating element 68a as specified by the fly height controller 57 in the power request.

FIG. 7C illustrates a system 140 in accordance with an embodiment of the present invention. The system 140 includes the circuitry 30, the preamp 49, and the heating element 68a. The circuitry 30 includes the fly height controller 57. The fly height controller 57 of the system 140 includes an equalizing network 58. In various embodiments, the equalizing network equalizes a power to be applied to the heating element 68a during FHA, so as to change the dynamics of the FHA response to substantially match that of the WPTP response and, thereby, substantially destructively cancel a net transient and produce a substantially constant flying height during read-to-write and write-to-read transitions.

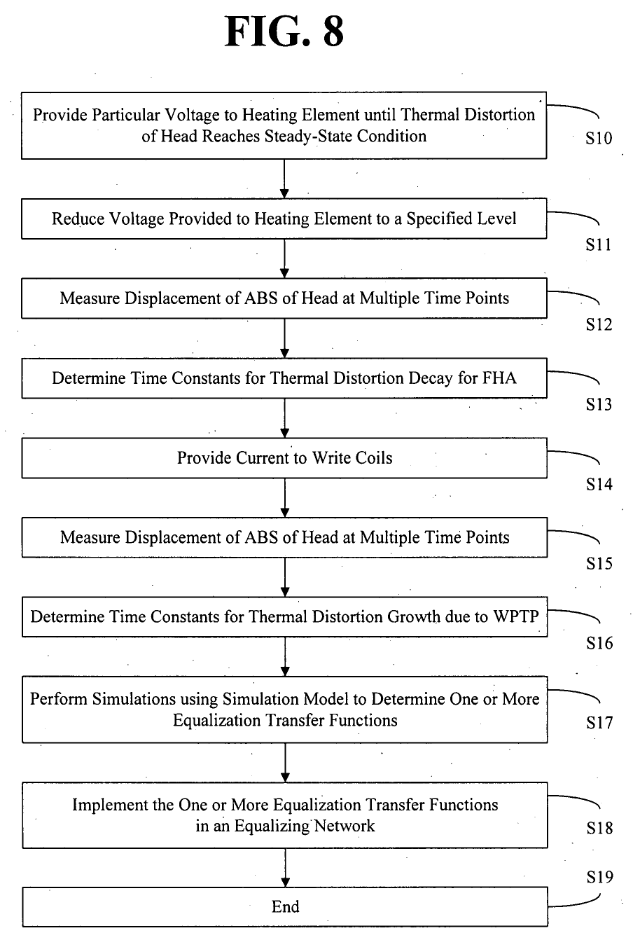

In various embodiments, experiments and/or simulations may be performed to determine a configuration of the fly height controller 57 or to determine one or more settings for the fly height controller 57. FIG. 8 illustrates a flowchart for a method in accordance with an embodiment of the present invention. In various embodiments, the method in FIG. 8 may be used to determine a configuration of a fly height controller or to determine one or more settings for a fly height controller, such that the fly height controller is able to control a heating element to maintain a substantially constant flying height of a head during transitions between read and write operations. In various embodiments, the method of FIG. 8 may be performed during a design phase or a set-up phase of a disk drive, and may be performed for individual disk drives, or may be performed with respect to a sample head for a sample disk drive of a batch of similar disk drives that are manufactured by a same process, and then the results of the method may be applied to all disk drives in the batch.

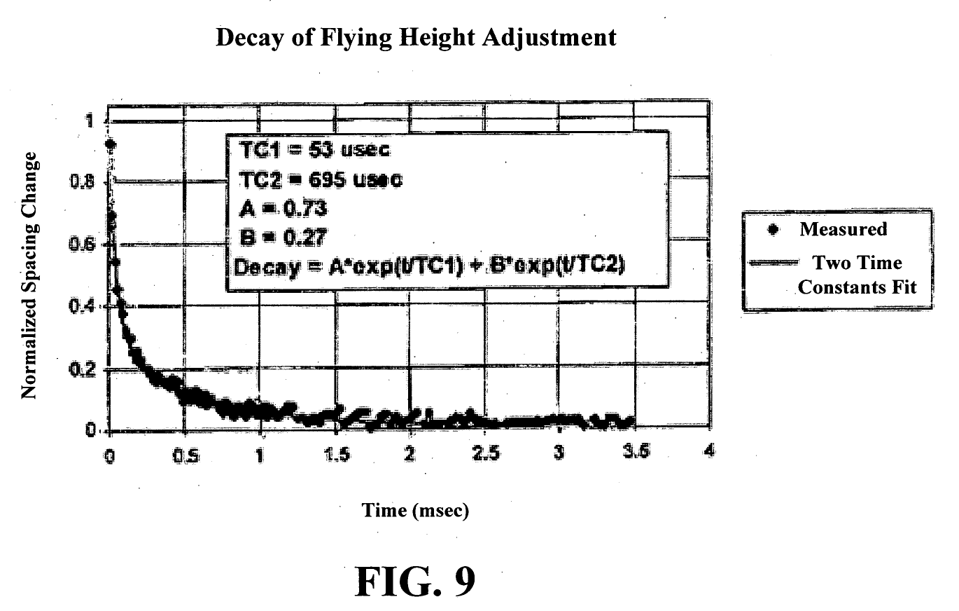

In step S10, a particular voltage is provided to a heating element until a thermal distortion of a head reaches a steady-state condition. The method then continues to step S11. In step S11, the voltage provided to the heating element is reduced to a specified level. In some embodiments, the specified level is 0 V, such that the voltage provided to the heating element is completely stopped. In various other embodiments, the specified level is a voltage that is to be provided to the heating element during write operations. The method then continues to step S12. In step S12, a displacement of an ABS of the head is measured at multiple time points after the voltage provided to the heating element is reduced to the specified level. An example of measured values of a displacement of the ABS of the head at multiple time points is illustrated in FIG. 9. In FIG. 9, example measured values of a normalized spacing change of the ABS of the head for various time points are plotted in a graph. The method of FIG. 8 then continues to step S113.

In step S13, time constants for thermal distortion decay for FHA are determined based on the measured values obtained in step S12. In various embodiments, the thermal distortion decay is assumed to be a multi-exponential function of the form: Decay=A*exp(t/TC_{1fha})+B*exp(t/TC_{2fha}), where TC_{1fha} is a first time constant, TC_{2fha} is a second time constant, and A and B are real values. For multi-exponential functions, TC_{1fha} is sometimes called a short time constant or a fast time constant, and TC_{2fha} is sometimes called a long time constant or a slow time constant. In various embodiment, a standard mathematical program is used to perform a fit of the measured values obtained in step S12, so as to determine the time constants TC_{1fha} and TC_{2fha} and the parameters A and B. An example of a fit of measured values for thermal distortion decay is illustrated in FIG. 9. In the example of FIG. 9, the time constants for the fit of the measured values were determined to be TC_{1fha}=53 μs and TC_{2fha}=695 μs, and the parameters A and B were determined to be A=0.73 and B=0.27. The method of FIG. 8 then continues to S14.

In S14, a current is provided to one or more write coils in the head, and the method continues to step S15. In S15, a displacement of the ABS of the head is measured at multiple time points, and the method continues to step S16. In S16, one or more time constants are determined for thermal distortion growth due to WPTP based on the values measured in step S15. In various embodiments, the thermal distortion growth is assumed to be a multi-exponential function with a first time constant TC₁ₚₜₚ and a second time constant TC₂ₚₜₚ, and parameters A and B. For example, sample determined parameters for WPTP in an experiment for a given head design were determined to be TC₁ₚₜₚ=49 μs, TC₂ₚₜₚ=686 μs, A=0.70, and B=0.30. The method then continues to step S17.

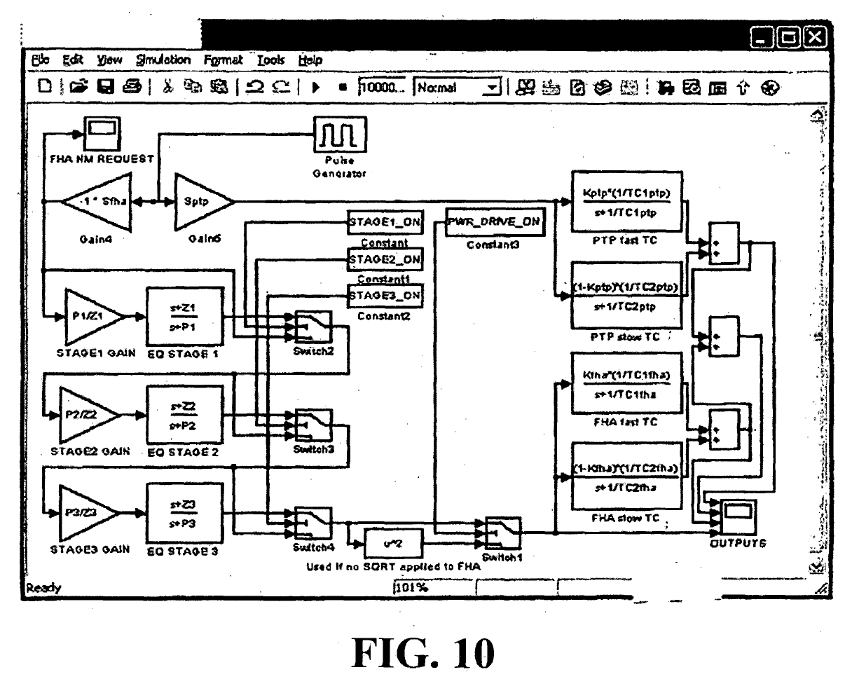

In S17, simulations are performed using a simulation model to determine one or more equalization transfer functions. In various embodiments, the time constants TC_{1fha} and TC_{2fha} for the thermal distortion decay for FHA, and the time constants TC₁ₚₜₚ and TC₂ₚₜₚ for the thermal distortion growth due to WPTP are used as parameters in a simulation model. FIG. 10 illustrates an example of a simulation model developed using the MATLAB® simulation tool. A simulation model as illustrated in FIG. 10 allows for modeling the dynamics of WPTP, FHA, and an equalizing network.

In the simulation model of FIG. 10, the effect of the fast time constant for WPTP is modeled by the transfer function labeled “PTP fast TC”, and the effect of the slow time constant for WPTP is modeled by the transfer function labeled “PTP slow TC”. Also, in the simulation model of FIG. 10, the effect of the fast time constant for FHA is modeled by the transfer function labeled “FHA fast TC”, and the effect of the slow time constant for FHA is modeled by the transfer function labeled “FHA slow TC”. In the simulation model of FIG. 10, the dynamics of the equalizing network are provided by transfer functions for three equalization stages labeled “EQ STAGE 1”, “EQ STAGE 2”, and “EQ STAGE 3”.

Three switches, labeled “Switch2”, “Switch3”, and “Switch4”, are provided in the simulation model of FIG. 10, so that the simulation model allows for simulation with one or more of the stages of the equalizing network enabled. In various embodiments, the simulation model is configured to simulate the effect of voltage equalization. In various other embodiments, the simulation model is configured to simulate the effects of power equalization. In some embodiments, Monte Carlo analysis is used to determine tolerance effects.

By performing simulations using a simulation model, such as the simulation model of FIG. 10, parameters for the equalization transfer functions, such as the functions in the stages labeled “EQ STAGE 1”, “EQ STAGE 2”, and “EQ STAGE 3” in FIG. 10, are able to be determined such that a transient fly height change resulting from a transition between a write operation and a read operation can be substantially destructively canceled. For example, a single order equalizer using one equalization transfer function in the simulation model has been found to attenuate flying height transient change amplitudes by as much as 60%. Also, a third order equalizer using three equalization transfer functions in the simulation model has been found to provide for complete correction of flying height transient changes for common head designs, such that the third order equalizer allows for attenuating a flying height transient change amplitude by approximately 100%.

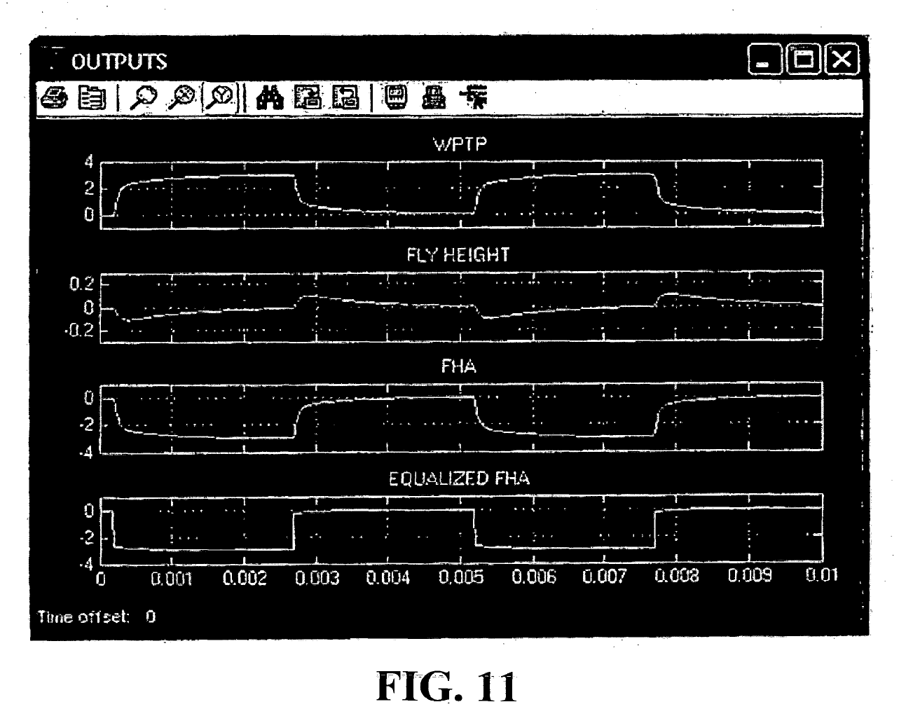

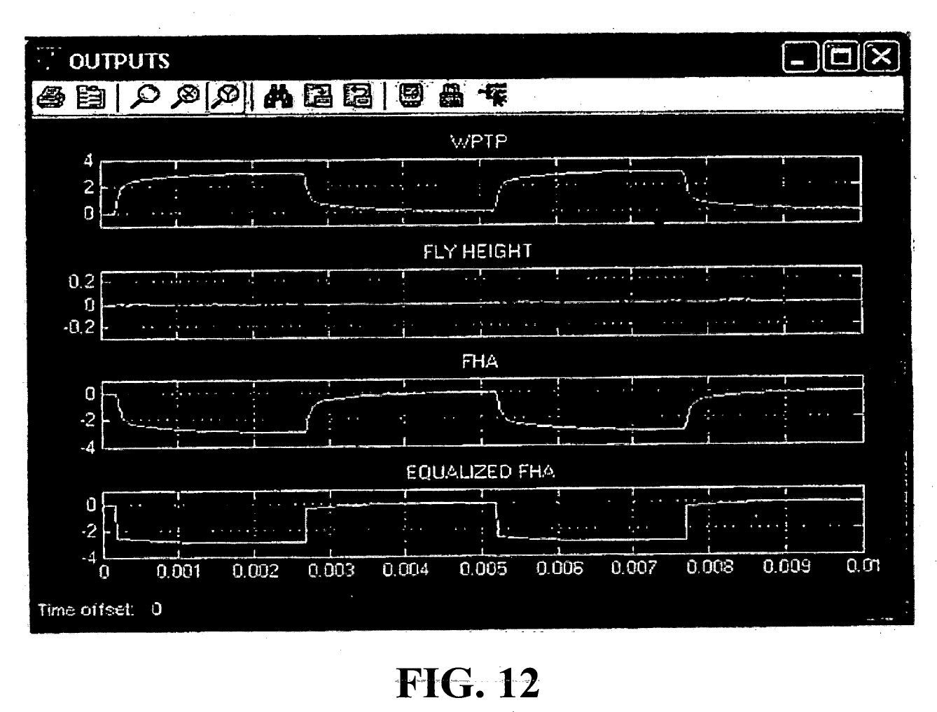

As an example, simulations were performed for a head design in which a natural (uncompensated) transient flying height change was approximately 10% of the WPTP value. For example, in a case where the WPTP is 3 nm, the transient flying height change in an uncompensated system would be 0.3 nm. In the case of a 1 nm flying height, the 0.3 nm transient change would represent 30% of the flying height budget and, thus, could lead to reliability problems. In simulations, a first order equalizer or compensator reduced the 30% error to less than 15%. A sample output result of a simulation with a first order equalizer is illustrated in FIG. 11, where simulation outputs for WPTP, FHA, Equalized FHA, and Fly Height are illustrated. Also, in a simulation, a third order equalizer or compensator reduced the 30% error to approximately 0%. A sample output result of a simulation with a third order equalizer is illustrated in FIG. 12, where simulation outputs for WPTP, FHA, Equalized FHA, and Fly Height are illustrated. As illustrated in FIG. 12, with a third order equalizer a fly height of a head is able to remain approximately constant during transitions between read and write operations.

In various embodiments, a complete structure of an equalizer transfer function is composed of three stages of lead/lag equalizers. A goal of such equalizers is to transform an unequalized response of a heater path, representing a response due to heat from a heating element, such that the equalized response of the heater path is identical to a response of a write coil path, representing a response due to heat from write coils. To the extent that the responses are equal, there is perfect cancellation and, for example, there may be no write gap fly height transient change during read-to-write or write-to-read transitions.

Moreover, in various embodiments, such an equalizer must reposition the two main poles of a heater transfer function, representing the response of the heater path, to match the two main poles of a write coil transfer function, representing the response of the write coil path. The two main poles in the heater transfer function and the two main poles in the write coil transfer function are all real. In some embodiments, the repositioning of the poles is performed by a third order equalizer. Parameters for the equalizer, such as a gain, a single pole, and a single zero for each stage come from the value of all four poles, which in the case of the simulation may be predetermined from characterization data.

With reference again to FIG. 8, after determining the one or more equalization transfer functions by performing the simulations in step S117, the method continues to step S18. In S18, a equalizing network is developed or settings in an already developed equalizing network are adjusted so as to implement the one or more equalization transfer functions determined in step S17. In various embodiments, the one or more equalization transfer functions are implemented as an equalizing network with components such as capacitors, resistors, op amps, active filters, or the like. In various other embodiments, the one or more equalization transfer functions are implemented as an equalizing network using a digital signal processor (DSP).

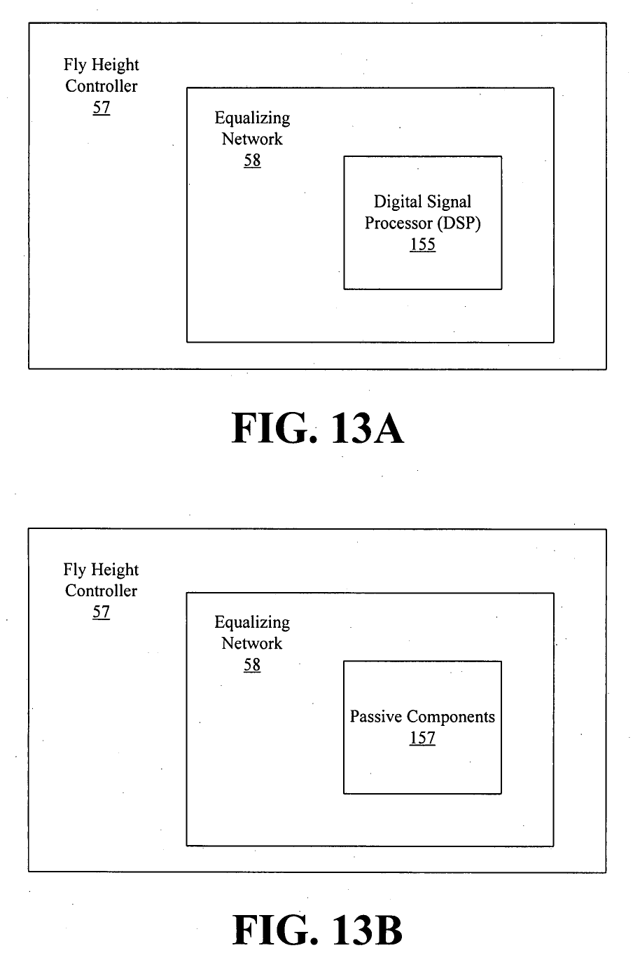

FIG. 13A illustrates an embodiment of the fly height controller 57 in which the fly height controller 57 includes the equalizing network 58 and the equalizing network 58 includes a DSP 155. In various embodiments, the DSP 155 is configured to implement one or more transfer functions determined based on a simulation to compensate for thermal distortion decay of the head 20a (refer to FIG. 5) due to reduced heat from the write structure 80 (refer to FIG. 5), where the one or more transfer functions implemented in the DSP 155 enable an attenuation of an amplitude of a transient fly height change by more than 60% of an amplitude of an uncompensated transient fly height change.

For example, the DSP 155 may be programmed to implement one or more equalization transfer functions as determined in a simulation of step S17 of FIG. 8. In various embodiments, the fly height controller 57 generates a signal, and the DSP 155 applies the one or more transfer functions to the signal to provide a compensated signal that is used to control the heating element 68a (refer to FIG. 5). In some embodiments, the DSP 155 is tunable to implement different equalization transfer functions, such that a desired equalization transfer function is able to be implemented based on a result of a simulation using values related to actual measurements of thermal distortion of a head due to a change in power dissipated by a write structure. In various embodiments, the DSP 155 is used for other control operations in addition to implementing the one or more equalization transfer functions and the DSP 155 is operated in a timesharing manner.

FIG. 13B illustrates an embodiment of the fly height controller 57 in which the fly height controller 57 includes the equalizing network 58 and the equalizing network 58 includes passive components 157. The passive components 157 may include, for example, capacitors, resistors, and the like. In various embodiments, the passive components 157 are configured to implement one or more transfer functions determined based on a simulation. In various embodiments, the passive components 157 are tunable to implement different equalization transfer functions, such that a desired equalization transfer function is able to be set by tuning the passive components 157. In various embodiments, the passive components 157 are able to perform a continuous equalization of a signal during read-to-write and write-to-read transitions. As illustrated in the simulation results shown in FIG. 11, a significant improvement in reducing transient changes in a flying height can be achieved with an equalizer of fewer than three stages. Thus, in various embodiments, a partial equalizer of fewer than three stages may be implemented for the equalizing network 58 using passive components.

Referring again to FIG. 8, once the one or more equalization transfer functions have been implemented, the method ends in step S19. Thus, by various embodiments of the method illustrated in FIG. 8, one or more equalization transfer functions for a head heater controller are able to be determined and implemented so as to allow for substantially destructively canceling a transient fly height change resulting from a transition between a write operation and a read operation.

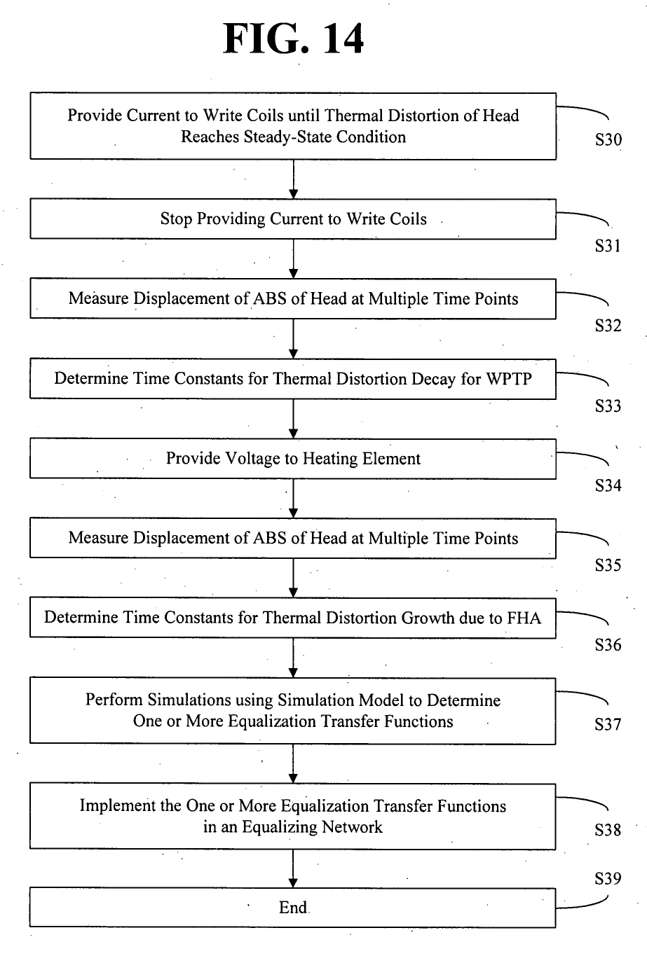

FIG. 14 illustrates a flowchart of a method in accordance with an embodiment of the present invention. In step S30, a current is provided to one or more write coils in a head until a thermal distortion of the head reaches a steady-state condition, and then the method continues to step S31. In S31, the current to the one or more write coils is stopped, and then the method continues to step S32. In S32, a displacement of an ABS of the head is measured at multiple time points to obtain multiple measured values, and then the method continues to step S33. In S33, one or more time constants for thermal distortion decay for WPTP are determined based on the values measured in step S32, and then the method continues to step S34.

In S34, a voltage is provided to a heating element in the head, and then the method continues to step S35. In S35, a displacement of the ABS of the head is measured at multiple time points to obtain multiple measured values, and then the method continues to step S36. In S36, one or more time constants for thermal distortion growth of the head due to FHA are determined based on the values measured in step S35, and then the method continues to step S37. In S37, one or more simulations are performed using a simulation model to determine one or more equalization transfer functions, where parameters in the simulation model are set based on the one or more time constants determined in step S33 and the one or more time constants determined in step S36. The method then continues to step S38. In S38, the one or more equalization transfer functions determined in step S37 are implemented in an equalizing network, and then the method ends in step S39.

A method in accordance with an embodiment of the present invention includes controlling a heating element when a head transitions from performing a write operation to performing a read operation such that thermal distortion growth of the head due to increased heat from the heating element substantially matches thermal distortion decay of the head due to reduced heat from a write structure. In various embodiments, an equalizing network as implemented by the method of FIG. 8 or by the method of FIG. 14 is used in a fly height controller to control the heating element in such a method.

In some embodiments, the controlling step of the method includes adjusting a power applied to the heating element in a time dependent manner in accordance with a function that has been determined to compensate for thermal distortion decay of the head due to reduced heat from the write structure. For instance, in various embodiments, the heating element may have an operating range of 0-150 mW. Also, for instance, the write structure may dissipate 60 mW during write operations. As an example, a power applied to the heating element may be adjusted between 65 mW and 60 mW in a time dependent manner during a transition from a write operation to a read operation. As another example, a power applied to the heating element may be adjusted between 55 mW and 60 mW in a time dependent manner during a transition from a write operation to a read operation.

In various embodiments, the method further includes controlling the heating element when the head transitions from performing a read operation to performing a write operation such that thermal distortion decay of the head due to reduced heat from the heating element substantially matches thermal distortion growth of the head due to increased heat from the write structure. In various embodiments, an equalizing network as implemented by the method of FIG. 8 or by the method of FIG. 14 is used in a fly height controller to control the heating element in such a method.

Referring again to FIG. 7C, in various embodiments, the fly height controller 57 provides a signal component calculated to offset a transient fly height change. In some embodiments the preamp 49 interprets a signal received from the fly height controller 57 as a voltage request to drive the heating element 68a with a voltage specified by the voltage request. Also, in some embodiments, the preamp 49 interprets a signal received from the fly height controller 57 as a power request to drive the heating element 68a to dissipate a power specified by the power request. There may be an advantage in having the preamp 49 be able to interpret requests from the fly height controller 57 as power requests rather than as voltage requests. This is because a temperature of the heating element 68a is proportional to a power dissipated by the heating element 68a, and the temperature of the heating element 68a affects the actuation of thermal distortion growth due to FHA, so it may be easier to make a compensation of the temperature substantially exact by specifying changes in terms of power rather than in terms of voltage, since power varies with the square of voltage.

In some embodiments, the fly height controller 57 is further configured to adjust a voltage supplied to the heating element 68a or a power applied to the heating element 68a during write operations. This is advantageous in situations in which a current in the one or more coils 88 (refer to FIG. 5) is changed as a function of time during a write operation, which is called write profiling. By measuring the time constants of the thermal distortions of the head 20a (refer to FIG. 5) due to the changes in power dissipated by the one or more coils 88 during write profiling, simulations are able to be performed to determine one or more transfer functions for equalizing a FHA response during such write operations.

The embodiments disclosed herein are to be considered in all respects as illustrative, and not restrictive of the invention. The present invention is in no way limited to the embodiments described above. Various modifications and changes may be made to the embodiments without departing from the spirit and scope of the invention. The scope of the invention is indicated by the attached claims, rather than the embodiments. Various modifications and changes that come within the meaning and range of equivalency of the claims are intended to be within the scope of the invention.

What is claimed is:

1. A circuit, comprising:
a head heater controller that substantially destructively cancels a transient fly height change resulting from a transition between a write operation and a read operation.

2. The circuit of claim 1,
wherein the head heater controller provides a signal component calculated to offset the transient fly height change.

3. The circuit of claim 1,
wherein the read operation precedes the write operation.

4. The circuit of claim 3,
wherein the head heater controller is configured to control a heating element during the transition from the read operation to the write operation such that thermal distortion decay of a head due to reduced heat from the heating element substantially matches thermal distortion growth of the head due to increased heat from a write structure.

5. The circuit of claim 1,
wherein the write operation precedes the read operation.

6. The circuit of claim 5,
wherein the head heater controller is configured to control a heating element during the transition from the write operation to the read operation such that thermal distortion growth of a head due to increased heat from the heating element substantially matches thermal distortion decay of the head due to reduced heat from a write structure.

7. The circuit of claim 6,
wherein the head heater controller comprises a digital signal processor configured to implement one or more transfer functions determined based on a simulation to compensate for the thermal distortion decay of the head due to reduced heat from the write structure; and
wherein the one or more transfer functions implemented in the digital signal processor enable an attenuation of an amplitude of the transient fly height change by more than 60% of an amplitude of an uncompensated transient fly height change.

8. The circuit of claim 1,
wherein the head heater controller is configured to adjust a power applied to a heating element in a time dependent manner in accordance with a function that has been determined to compensate for transient fly height changes.

9. The circuit of claim 1,
wherein the head heater controller is configured to adjust, in a case where a write current provided to a write structure during the write operation varies, an amount of heat provided by a heating element during the write operation so as to maintain a substantially constant flying height of the head away from a recording medium during the write operation.

10. A system, comprising:
circuitry for controlling a heating element, the heating element allowing for providing heat to a head, the head allowing for performing read operations and write operations;
wherein the circuitry is configured to control the heating element during a transition from a read operation to a write operation such that thermal distortion decay of the head due to reduced heat from the heating element substantially matches thermal distortion growth of the head due to increased heat from a write structure.

11. The system of claim 10,
wherein the circuitry is configured to control the heating element during transitions from write operations to read operations such that thermal distortion growth of the head due to increased heat from the heating element substantially matches thermal distortion decay of the head due to reduced heat from the write structure.

12. The system of claim 10,
wherein the circuitry is configured to adjust, during the transition from the read operation to the write operation, a power applied to the heating element in a time dependent manner in accordance with a function that has been determined to compensate for thermal distortion growth of the head due to increased heat from the write structure.

13. The system of claim 10,
wherein the circuitry comprises an equalizing network for equalizing a power applied to the heating element based on a write pole tip protrusion response due to power dissipated by the write structure.

14. The system of claim 10,
wherein the circuitry is tunable to implement different equalization transfer functions, such that a desired equalization transfer function is able to be implemented based on a result of a simulation using values related to actual measurements of thermal distortion growth of the head due to increased heat from the write structure.

15. A method, comprising:
controlling a heating element when a head transitions from performing a write operation to performing a read operation such that thermal distortion growth of the head due to increased heat from the heating element substantially matches thermal distortion decay of the head due to reduced heat from a write structure.

16. The method of claim 15, further comprising:
controlling the heating element when the head transitions from performing read operations to performing write operations such that thermal distortion decay of the head due to reduced heat from the heating element substantially matches thermal distortion growth of the head due to increased heat from the write structure.

17. The method of claim 15, wherein said controlling, comprises:
adjusting a power applied to the heating element in a time dependent manner in accordance with a function that has been determined to compensate for thermal distortion decay of the head due to reduced heat from the write structure.

18. The method of claim 15, further comprising:
measuring values related to thermal distortion decay of the head due to reduced heat from the write structure; and
determining one or more time constants related to thermal distortion decay of the head based on the measured values.

19. The method of claim 18, further comprising:
performing a simulation using the one or more time constants to determine an equalization transfer function that allows for substantially compensating for transient changes in a flying height of the head.

20. The method of claim 19, wherein said controlling, comprises:
controlling the heating element using the equalization transfer function when the head transitions from performing the write operation to performing the read operation such that thermal distortion growth of the head due to increased heat from the heating element substantially matches thermal distortion decay of the head due to reduced heat from the write structure.
